(19) United States
(12) Patent Application Publication
(10) Pub. No.: US 2003/0084453 A1
(43) Pub. Date: May 1, 2003

(54) System and method for providing product information over an interactive television system

(75) Inventors: Matthew Laughlin, Norwell, MA (US); Colin Campbell, Norwood, MA (US)

Correspondence Address: Alfred A. Stadnicki, LALOS & KEEGAN, Fifth Floor, 1146 Nineteenth Street, N.W., Washington, DC, 20036, US

(73) Assignee: Commerce TV Corporation

(21) Appl. No.: 09/985,113

(22) Filed: Nov. 1, 2001

(51) Int. Cl. H04N 5/445; G06F 3/00; G06F 13/00; G06F 17/60

(52) U.S. Cl. 725/60; 725/39; 705/26

(57) ABSTRACT

A system and method are provided for creating and delivering programming enhancements for interactive commerce in a television distribution network. The system includes databases of program schedule information, product information on items available for purchase, and available enhancement layouts. A computer application allows the creation of customized program enhancements, each containing product information relating to a particular program. The system further includes broadcasting apparatus to broadcast program enhancements to viewers on the network at an appropriate time so as to have each enhancement available for display to the viewers during the particular program with which it is associated. To conserve system resources, the program enhancements are assembled, formatted and queued for broadcast only shortly before the associated programs are aired. Received program enhancements are stored on viewers' set top boxes, and activated when the set top boxes receive a trigger that is broadcast with the associated programs.

### FIELD OF THE INVENTION

This invention relates generally to interactive video programming enhancements and in particular to the creation and delivery of such enhancements in a broadcast distribution network.

### BACKGROUND OF THE INVENTION

Interactive television is revolutionizing the cable and satellite television industries, changing television viewing from a purely passive experience into one that permits the viewer to participate in a wide range of activities. In a traditional cable or satellite television system, a set top box receives multiple channels of programming content from a cable or satellite television operator, and transmits to the television receiver the specific programming content on a channel selected by the viewer. The transmission of information occurs in one direction only, from the cable operator, via the set top box, to the television receiver for viewing by the viewer. In an interactive television system, by contrast, the cable distribution system supports an Internet-style two-way TCP/IP data link in addition to the regular broadcast channels, allowing the viewer to send messages over the network back to the cable head end in response to the programming or to informational messages sent with the programming. In such interactive systems, the set top box also functions as a digital computer, and is able to store and run application programs that permit two-way communications between the viewer and the cable operator, as well being able to support a variety of other interactive functions such as video games, virtual VCR capabilities and the purchasing of products and services.

It has been common in conventional one-way broadcast systems to deliver informational messages to viewers independently of any programming content, such as in the case of severe weather warnings or late-breaking news. However, conventional broadcast systems are increasingly delivering informational messages that are directly related to the program being broadcast. A very common example is closed captioning. Closed captioning is a service that uses the vertical blanking interval (VBI) of a conventional analog video signal to transmit digital data, in this case text, to the television receiver, where it is decoded and displayed to the viewer with its related programming.

In interactive television, an informational message is sent to the viewer with the intent of eliciting a response, most often in conjunction with the particular program to which the message relates. In interactive commerce, a viewer may, for example, be given the opportunity to indicate his or her desire to receive marketing or promotional materials or samples of a particular product or service being advertised on that program, or even to purchase such products and services. Viewing the information message in conjunction with a related program creates a sense of immediacy or urgency that increases the likelihood of the viewer responding to the message.

If an interactive system is used for television commerce, it is critical that the pre-recorded messages, or other similar program “enhancements”, be displayed to the viewer at the appropriate point within the associated program. If, for example, the intention of an enhancement is to solicit the viewer's interest in receiving a glossy brochure on a particular automobile during a commercial for that same automobile, then it is important that this enhancement be displayed during the typical 30-second duration of such a commercial. Seeing the enhancement after the commercial has ended and the sleek, gleaming vehicle is no longer visible on the screen, the viewer's excitement and interest in the vehicle may have already faded and a response, therefore, less likely. Thus, the enhancement delivery system must ensure that enhancements are available for display at the set top box when they are needed.

On-air closed captioning, mentioned above, is one example of the various techniques have been developed or proposed over the years for delivering informational messages to television viewers. The Advanced Television Enhancement Forum (ATVEF) has adopted a specification under which a unique signal, or “trigger”, can be inserted into the video programming to indicate to a viewer the availability of an informational message associated with the trigger. The ATVEF trigger takes the form of a Uniform Resource Locator (URL) that is inserted into line 21 of the analog video signal's vertical blanking interval. This technique has been applied for example, in one proposed system in which a viewer uses the URL transmitted with a television program to request a server at the cable system head-end to download related information from Internet web pages. This approach can be called a “pull” system because in order to receive the informational message, the viewer must request and pull it from a server remote from the set top box. However, this approach fails to adequately take into account the limitations on the speed at which enhancements can be transmitted to viewers over a television programming network, particularly one using analog technology. The size of an enhancement for television commerce, which can include images as well as text, may be such that it would not be available in a timely fashion if it were to be downloaded from a broadcast station or cable head-end while the related program segment is already in progress. It would be advantageous, instead, to use a “push” system that broadcasts program-related enhancements to set top boxes in advance and triggers their activation later at the appropriate time during the related programming segment or commercial.

Current set top box technology also imposes other limitations on enhancements intended for use in a television commerce application. For example, set top boxes usually have a more limited graphics capability than personal computers, and any system for creating enhancement layouts must take these limitations into account. In addition, set top boxes do not typically provide for mouse or keyboard inputs, so enhancement layouts have to be capable of being navigated with the buttons on a typical TV remote control.

Because of set top box memory limitations and transmission speed constraints, it is essential that enhancements for television commerce contain the minimum amount of data necessary to produce on-screen displays of acceptable appearance, and that they be delivered only shortly before they are scheduled to be activated. Enhancements should also be broadcast in a commonly accepted format that is compatible with the various set top box operating systems that are currently in use.

### OBJECTIVES

Therefore, it is an object of the present invention to provide a comprehensive system for creating and delivering programming enhancements for interactive commerce in a network using television set top boxes.

It is another objective of the present invention to facilitate the creation of programming enhancements with a customized look and feel for a broad variety of products and targeted to geographically diverse groups of viewers.

It is a further objective of the present invention to be able to ensure program enhancement availability at the set top boxes so as to facilitate timely display with the related programming on the associated television receiver.

It is yet a further objective of the present invention to provide for delivery of programming enhancements in a commonly accepted format compatible with a wide variety of set top boxes.

The above-stated objectives, as well as other objectives, features and advantages, of the present invention will become readily apparent from the following detailed description, which is to be read in conjunction with the appended drawings.

### SUMMARY OF THE INVENTION

The present invention is directed to the provision of product information in a broadcast network using television set top boxes. A system embodiment includes a database of television program schedule information, a database of product information on items available for purchase, and a processor, running a software application called the EBG (Electronic Buying Guide) Application, that allows a user to create, through a series of user inputs, an association between certain of the product information and one of the scheduled televisions. The product information associated with the program is preferably a list of items available for purchase that the user can select from the database of product. The associated product information may also include additional graphic or textual information, or both, related to each of the items on the list of purchasable items. In the preferred embodiment, the program with which the product information is associated may be an entire scheduled program, a segment of one of the scheduled programs, or a separate short presentation, such as a commercial or public service announcement.

The present invention further includes a second processor to direct the broadcast of the product information to a viewer terminal, typically a television set top box, at a time prior to the scheduled broadcast time of the television program with which product information is associated. The viewer terminal receives the television program and the product information and displays the enhancement with the associated program to a television viewer, giving the viewer an opportunity to respond to the product information.

In another aspect of the invention, the product information, which is broadcast in advance of the particular program to which it is related, is stored in the viewer terminal and displayed when the viewer terminal receives a trigger signal with the particular program. The trigger signal preferably contains an identifier that uniquely relates the product information to the program. Availability of the product information is preferably indicated to the viewer by the appearance of an icon on the television display, to which the viewer may respond by pressing a button on his or her television remote control to make the product information itself appear.

Typically, the viewer terminal will be an advanced analog or digital set top box of the type commonly used in cable television distribution systems. However, the method of the present invention can be successfully implemented by incorporating the functionality of the set top box into the television set or other appliance used to display the broadcast program.

In a further aspect of the invention, the user can, at the time the product information is being selected, access a database of layouts, that is, formats in which the product information can be displayed, and select a format to be associated with the product information. The viewer terminal is configured to respond by displaying the product information in the selected format. Preferably the viewer terminal has stored within it the essential features of each format, and the format information contained in the broadcast enhancement relates only to a limited number of feature parameters, such as color and type style, that can be customized.

In another aspect of the invention, the second processor broadcasts the product information on the same channel on which the associated program is scheduled to be broadcast. In the preferred embodiment, the broadcasting process is handled by a software application called the Data Streamer System (DDS) running on a processor at the broadcast network head end. In an analog television system, the DSS preferably broadcasts the product information and layout information via the vertical blanking interval of the analog television signal.

In a further aspect of the invention, the second processor converts the product data and related format information to an XML (Extensible Markup Language) format prior to broadcasting, and the viewer terminal is capable of converting the XML-formatted information into a form suitable for display to the viewer. The second processor is further configured to packetize the product and format information prior to broadcast, in order to minimize transmission errors, and the viewer terminal reassembled the information from the packets for storage and subsequent display.

In a yet further aspect of the invention, the EBG application, running on the first processor, allows the user to select by geographical or other criteria the television broadcast channels over which the program enhancement will be broadcast, allowing different enhancements to be broadcast to selected audiences, even with the same program.

The preferred embodiment described herein contemplates a number of processors and databases in a distributed architecture running the software applications that provide the functionality of the present invention. However, a different architecture of processes and databases can be used to practice the invention with equivalent effect.

### BRIEF DESCRIPTION OF THE DRAWINGS

FIGS. 1A-1B show a system for creating and delivering programming enhancements in a interactive television system in accordance with the present invention;

FIG. 2 shows an example of a television program enhancement that can be created and delivered with the present invention;

FIGS. 3A-3F show screen shots of the EBG application used to define EBG masters according to the present invention;

FIG. 4 shows the structure of an EBG master according to the present invention;

FIG. 5A shows a functional block diagram of the Data Streamer System used to broadcast enhancements according to the present invention;

FIG. 5B shows the structure of an enhancement data package broadcast by the Data Streamer System; and

FIG. 6 is a flow chart of the method for creating and delivering programming enhancements according to the present invention.

### DETAILED DESCRIPTION OF THE INVENTION

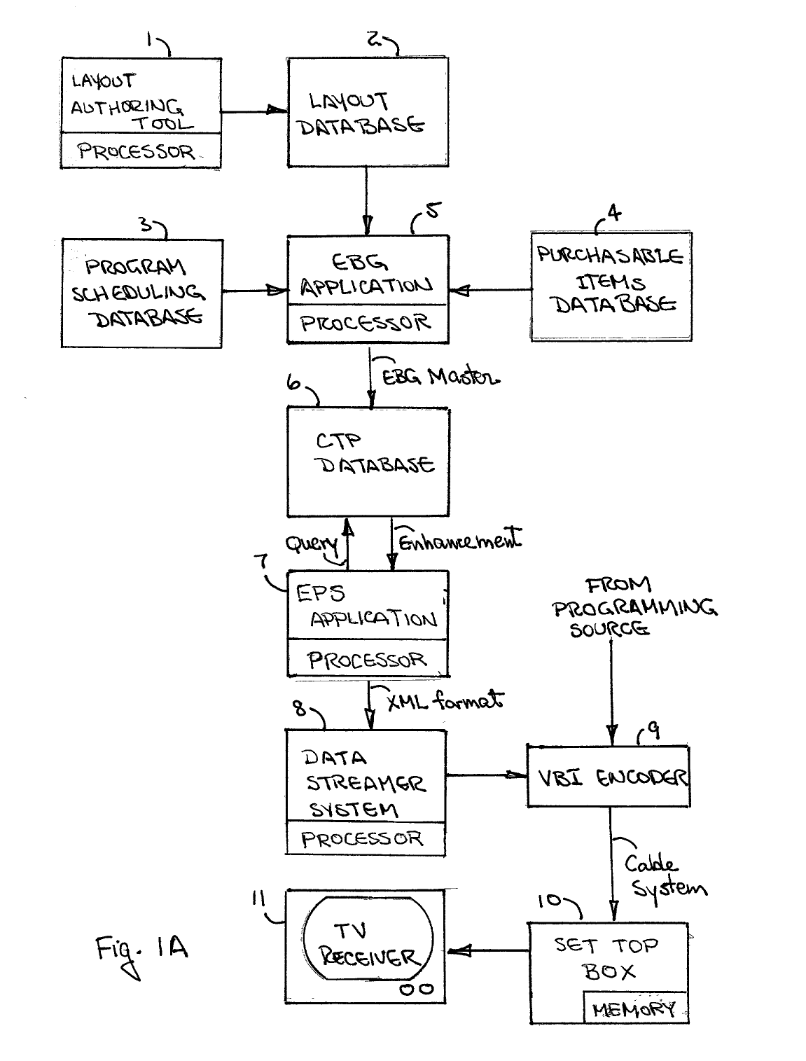

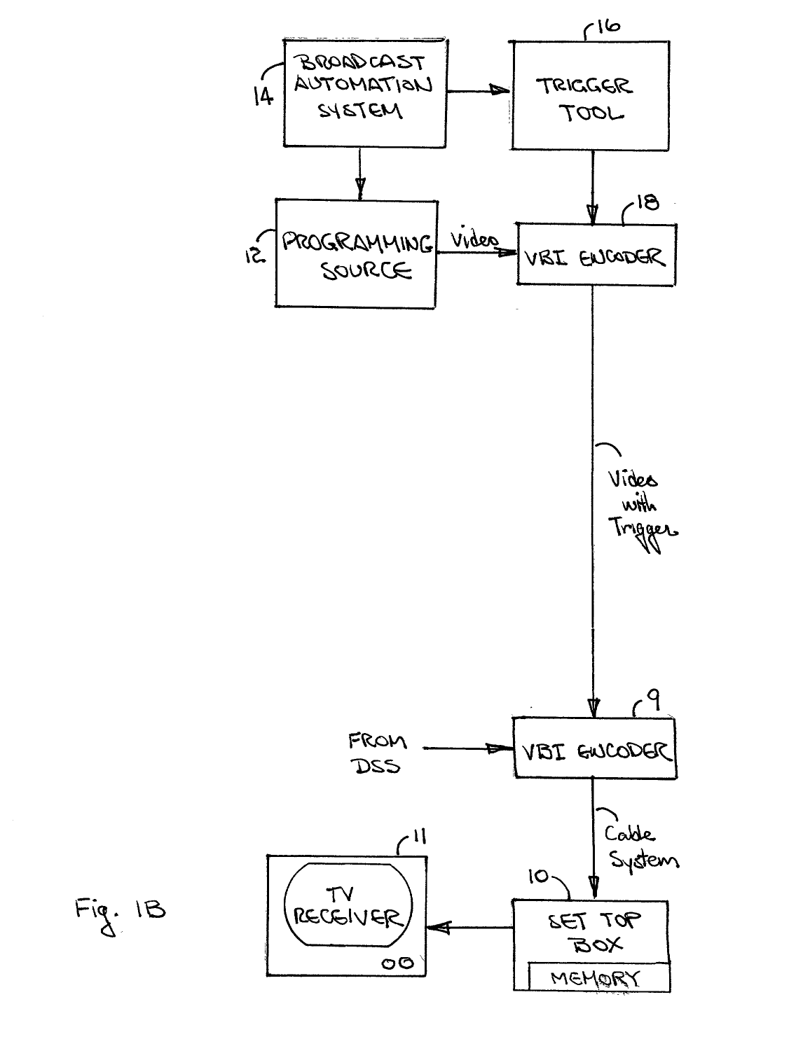

FIGS. 1A-1B show in block diagram form the preferred embodiment of the present invention. Referring to FIG. 1A, the set top layout authoring tool (SLAT) 1 represents the first step in creating broadcast program enhancements for interactive commerce. The authoring tool creates layouts that are filled later in the process with text and graphic product information to form complete enhancements.

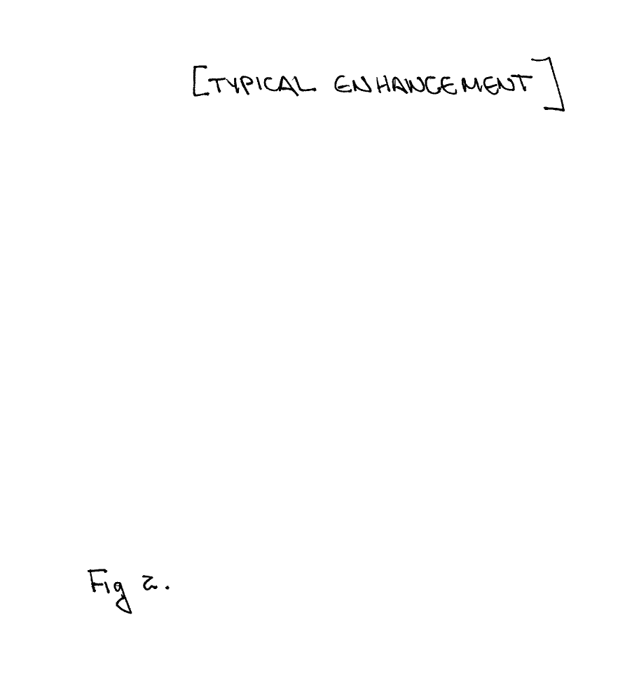

The layouts created by the authoring tool are specifically intended for presenting product information on a television screen. The layouts are simpler than those that might be presented on a computer screen because of the more limited graphic capabilities available in television set top boxes. A typical television program enhancement is shown in FIG. 2. The enhancement forms an overlay on the current television programming and serves as the viewer's initial contact with the interactive commerce system. The principal features of the enhancement shown are the list of available products (no.), logo (no.), branding bar (no.) and response buttons (no.). The graphics box (no.) and text box (no.) provide additional information about any item on the list selected by the viewer. Using the response buttons (no.), the viewer can request detailed information about a selected item, save an item in a list of favorites for later consideration, or initiate an interactive purchase sequence.

The authoring tool is a software application with a graphical user interface that presents to the user a menu of basic layouts, typically about five in number, each of which may be customized in certain respects for the vendors and broadcasters that will be using them. In general, the basic size and placement of the different features in each layout, such as lists, graphic windows and buttons, are predefined and not alterable. On the other hand, the user can alter some of the parameters of the features, such as colors, fonts, shading, screen transparency, button labels and logos, to give the enhancement a customized appearance.

The number of basic layouts has been limited in the preferred embodiment to minimize the amount of layout information that must be sent to the set top boxes with each enhancement. The features of the basic enhancements are stored in the set top box as part of a software application that supports the display of the enhancements to the viewer. Only the selectable feature parameters, such as colors and type fonts, need to be sent in order to customize the display. To be commercially acceptable, the system must address viewers that have the least capable equipment. With existing technology, it was determined that about five basic layouts could be effectively supported in this manner. As set top boxes and data transmission rates in television distribution systems generally improve, the number of layouts and selectable parameters can be increased accordingly.

The limitation of user choices in basic layouts has the benefit of making the authoring process more user friendly. Users with little skill or experience should find the authoring tool easy to learn and use.

The output of the authoring tool is a layout definition in XML (Extensible Markup Language). XML is a language capable of efficiently representing the layout definition in a manner compatible with a variety of different platforms. The software application running on each set top box to support interactive commerce will include an XML reader, or decoder, to take the layout definition in XML and convert it into a graphical representation of the layout consistent with the language used by the particular set top box operating system. For example, Scientific Atlanta set top boxes run under C language, while General Instruments set top boxes use HTML.

The layouts created by the authoring tool are also designed to accommodate the limited on-screen navigation capability of presently available set top boxes. Set-top boxes typically use no mouse or keyboard, relying on the TV remote control as an input device. As a result, navigation is limited to using buttons on the remote control to move step-wise through a sequence of choices on the television screen in either an upward or downward direction, or left or right. Navigation techniques familiar to computer users, such as “point and click” and “drag and drop”, are not available with a set-top box and remote control.

Continuing with reference to FIG. 1A, the set top box layouts created with the layout authoring tool 1 are stored in the layout database 2, where they are available to the EBG (“Electronic Buying Guide”) application 3. The EBG application also draws from information stored in the program scheduling database 4 and the purchasable items database 5. The role of the EBG application is to select data from these three databases that together will define each of the programming enhancements.

The program scheduling database 3 contains information from a third-party vendor, such as TVData of Glen Falls, N.Y., that includes a file of the planned daily program schedules for each channel into which enhancements may be inserted. The data in the schedule file relates each program, identified by program name and ID number, to a channel ID, program start time and duration. Other files in the program scheduling database 3 relate each channel ID to the head end of the cable system with which the channel is associated, and identify the multiple system operator (MSO) with which the head end is associated. The data received from the third party vendor also contains zip code and location information associating each head end with a specific geographical area. After the download of program scheduling data for an initial period of time, such as 60 days, the vendor provides daily updates to the programming data including schedules for one new day of programs and corrections to schedules already received.

The program scheduling database can also be accessed manually for adding, deleting or modifying schedule information. This capability is most important in the case of scheduling program segments and commercial messages, which do not appear on commercially available television schedules.

The database of purchasable items 5 provides the names and other data, such as price, size and color, about items that may be purchased using the system. In addition to data on individual items, database 5 typically contains lists of purchasable items that have been previously prepared in connection with enhancements for particular programs or advertisers, and that may be reused or modified for new enhancements.

The EBG application 5 is a software-driven process that goes through a series of steps to create a “EBG master” for each enhancement that defines all of the elements the complete enhancement will require. The EBG application provides the user with a series of screens that allow the user to create the EBG master using the information from the layout database 2, the purchasable items database 4, and programming scheduling database 3. For each enhancement, the user must select a basic or customized layout, create a list of purchasable products related to the enhancement, and associate the enhancement with a specific program time slot.

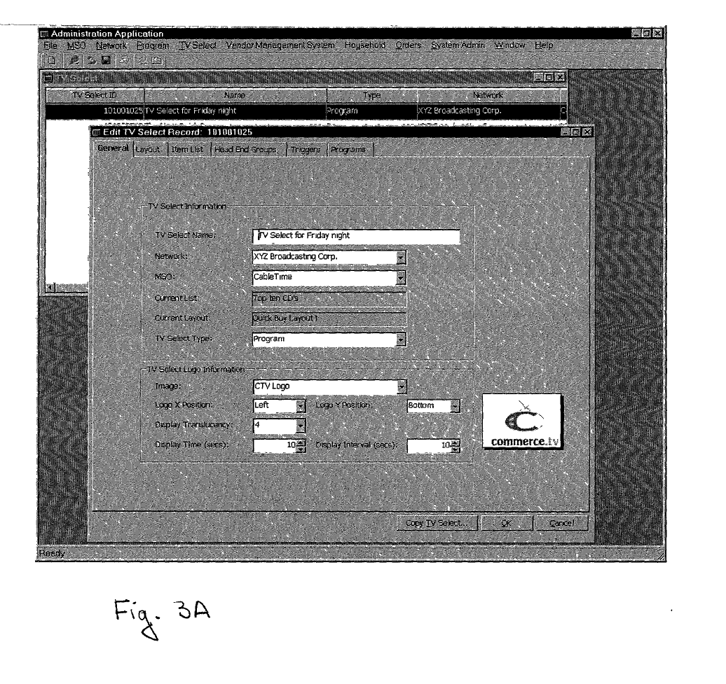

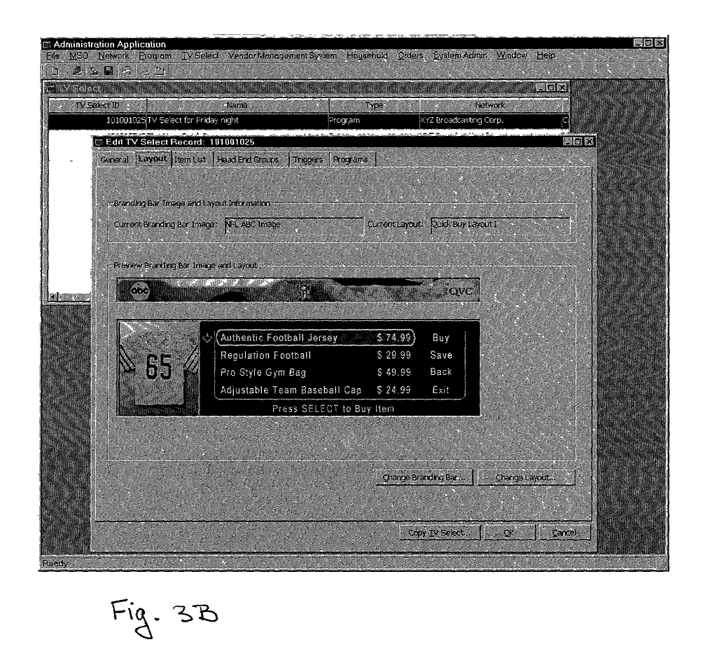

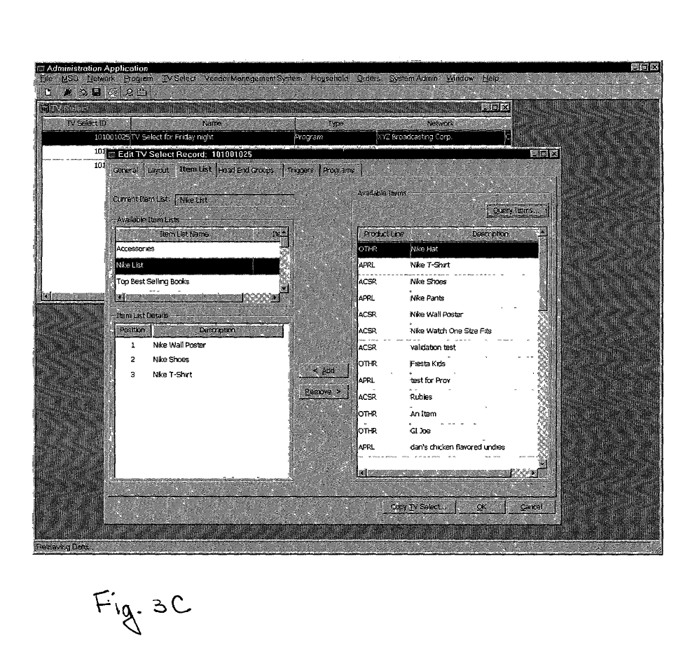

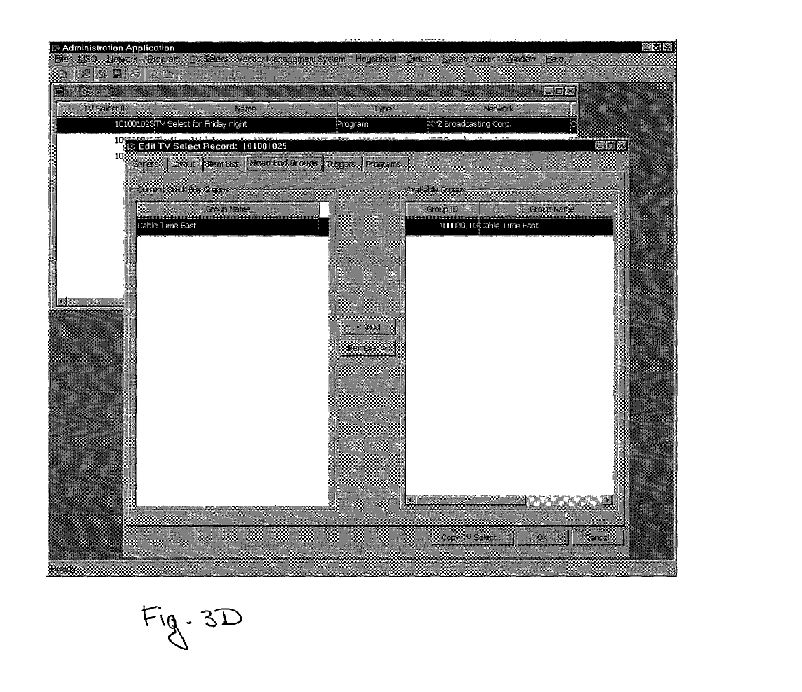

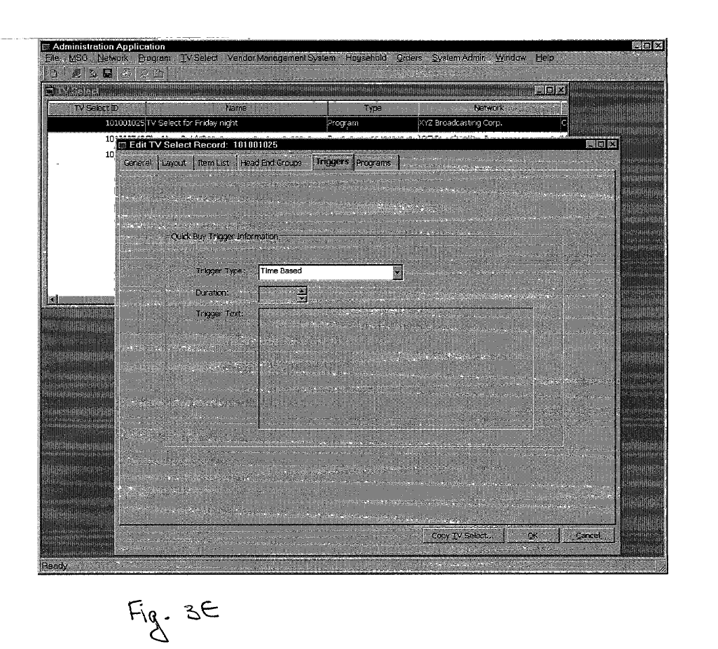

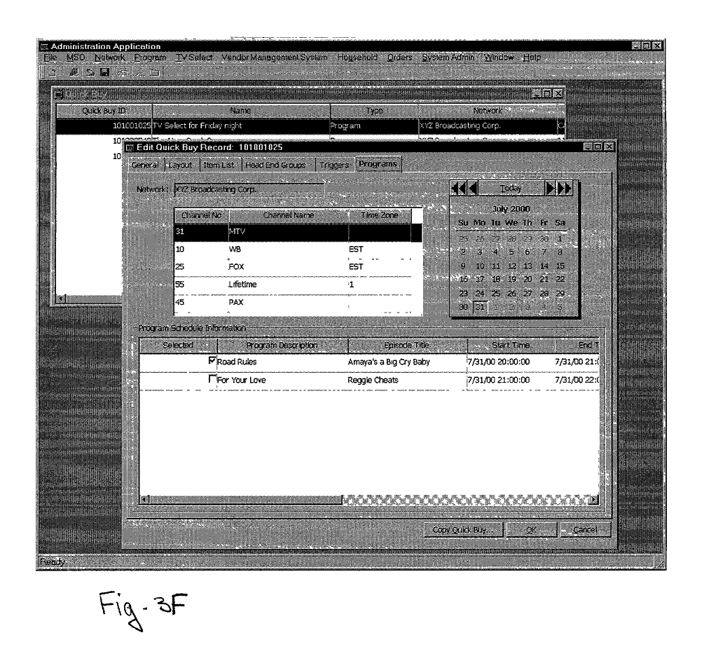

FIG. 3A shows one of the tab screens that the user will see when using the EBG application. The process of creating an enhancement definition, or EBG master, typically starts with identifying the network and MSO on whose program and system the enhancement will appear. The EBG application employs a hierarchical decision system such that alternatives presented later in the process will depend upon the user's initial choices, thereby eliminating later alternatives that are inappropriate or invalid. For example, an initial choice of network and MSO will limit the choices available for enhancement features such as the on-screen branding bar. It would certainly not be appropriate, for example, to be able to choose an NBC logo for the branding bar if the program is provided by CBS.

As shown in FIG. 3A, the General tab screen gives the user the opportunity to define other features of the enhancement, including a name for the enhancement, a logo that will appear with the enhancement, and certain features of the logo, such as position transparency and duration.

FIG. 3B shows the Layout screen, another tab screen that enables the user to choose an appropriate layout from the layouts provided by the authoring tool 1, and stored in the layout database 2. If there are customized layouts for a selected MSO or network that meet their specific stylistic requirements, than those layouts will be presented in the layout tab screen. Another definable feature shown on this screen is the branding bar, mentioned earlier, that can contain three trademarks to identify the network, the MSO and the advertiser involved with the enhancement.

The Item List tab screen, FIG. 3C, allows the user to define a list of purchasable items that will be associated with the enhancement. The user can select an existing list that may be associated with one of various advertisers or programs, such as a Nike sport shoes or the NFL, modify an existing list by adding or deleting items, or create an entirely new list from available items in the purchasable items database 4. Each list has a name associated with it that will be included in the enhancement definition.

The Head End Groups tab screen, FIG. 3D, allows the application user to associate each enhancement with a particular head end, or group of head ends, of an MSO. This allows, through use of the geographic information in the program scheduling database 3, targeting of specific geographical groups of customers for particular enhancements. By this means, two different enhancements can be shown to two different audience groups watching the same program. Although not implemented in the preferred embodiment, the capability exists to target individual viewers or viewer interest groups through use of the unique ID number that is associated with each set top box.

The Trigger tab screen, FIG. 3E, allows the application user to enter trigger information that will determine exactly when an enhancement will be activated at the set top box. As explained in greater detail below, enhancements will be broadcast through the programming distribution network in advance of the associated programming and stored in the set top boxes until activated at a specific time by a broadcast-based trigger. Trigger duration can be set to determine the length of time the corresponding enhancement will remain activated after the trigger is received.

The Programs tab screen, FIG. 3F, allows the EBG application user to assign programs to enhancements by selecting specific timeslots from a channel's schedule, each timeslot being defined in terms of a specific channel, start date and start time. Since timeslots are associated with channels, the user must first select the channel, then a date, or date range, and optionally a time range. The application will then display a list of programs scheduled to air on that channel within the date/time range, and one or more programs can be selected from the list for the enhancement. Any particular enhancement can be associated with time slots on more than one channel, the only limitation being that the channels must be associated with the same network (e.g., NBC), which is selected before the time slots are selected.

As indicated earlier, the output product of the EBG application is an EBG master that defines the information to be incorporated in the corresponding enhancement. Each EBG master is essentially a collection of pointers to files that contain the details of the enhancement, including the layout, purchasable item list and channel/timeslot information. This scheme avoids unnecessary replication of detailed data that may be associated with more than one enhancement. The EBG masters and the detailed data necessary to support them are sent by the EBG application 5 to the CTP database 6. Preferably, this data is sent to the CTP database on a daily basis, and is limited to the enhancements scheduled to be downloaded to set top boxes the next day, so that storage space in the CTP database is conserved. Daily transmission also allows the data to reflect the most current program scheduling updates.

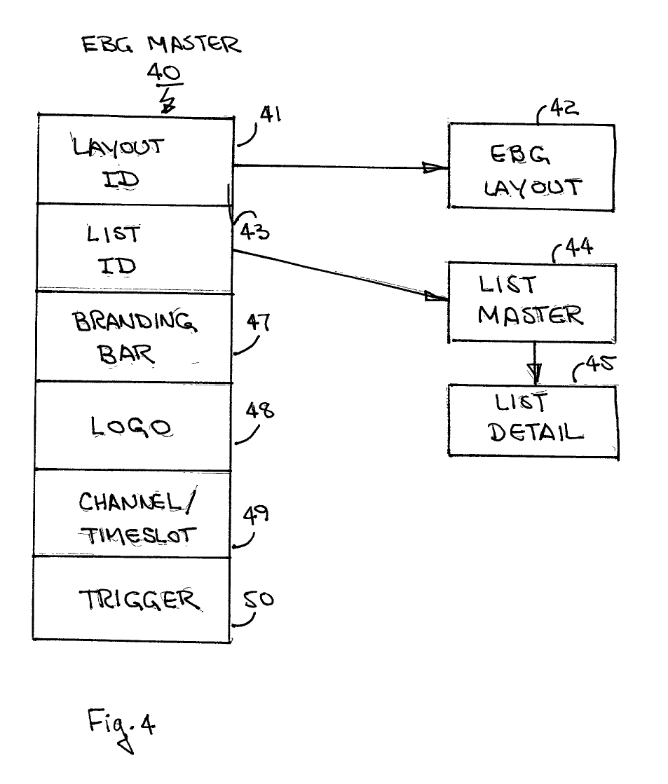

FIG. 4 shows the structure of an EBG master residing on the CTP database 6. Each EBG master 40 has a number of elements, which, as noted above, identify, or point to, data files in the CTP database containing the details of the element. For example, one of the elements is a Layout ID 41 that points to an EBG layout 42 in XML format containing specifications for the various appearance parameters of the enhancement, such as color and font style. There is also a List ID 43 that points to a List Detail 44 containing names and ID numbers of the items on the specified list that are being offered for purchase. The List Detail in turn points to Item Detail 45 regarding each of the items in the lists. The EBG master also contains pointers to image elements, such as the branding bar 47 and the vendor logo 48. With regard to scheduling, the EBG master contains reference to the relevant head end/channel/timeslot information 49 and trigger information 50.

Referring again to FIG. 1A, the Enhancement Packaging and Scheduling (EPS) service 7 is a software application running on a processor, whose functions are to periodically query the CTP database 6 to identify which enhancements need to be downloaded to the set top boxes in the immediate future, to retrieve from the CTP database the detailed data required for the identified enhancements, to assemble the enhancements and convert all of the elements of the enhancements to XML format, to validate the resultant XML code, and to send the completed enhancement on to the Data Streaming System (DSS) 8 at the appropriate time for downloading to the set top box boxes.

The first step in the process, as noted above, is for the EPS 7 to query the CTP database 6 as to which enhancements need to be prepared for downloading to set top boxes in the next interval. The length of that interval will depend of the time needed to process each enhancement and can be set dynamically to account for the volume of enhancements being processed. This first query returns a list of enhancements for each specific head end to which enhancements are to be sent. In the next step, the EPS retrieves from the CTP database, detailed files for those elements needed to assemble complete XML code for each enhancement in the list. The customized layouts, which are provided in XML format by the authoring tool 1, do not require conversion. Other elements, such as the item list and list detail, are, in the preferred embodiment, in Oracle database format and are converted to XML format using an Oracle XML parser. Picture elements, such as the vendor logo, branding bar and activation icon, which in the preferred embodiment have been generated in JPEG format, are converted to MIME format using a custom JAVA encoder, so the that they can be embedded in the XML code. After all of the elements of the enhancement have been assembled in XML format, the entire enhancement is validated using, in the preferred embodiment, the validation functions of the above-mentioned Oracle XML parser. The validation process confirms that each enhancement conforms to the applicable specification established for XML messages being sent the set top boxes, and hence ensures that each enhancement will behave appropriately when received and decoded. At the appropriate time in advance of activation, each enhancement that has been prepared by the EPS is sent by the EPS to the Data Streaming System (DSS) 8 to be downloaded in the appropriate broadcast channel. Thus, the EPS serves as a buffer to ensure that enhancement data is retrieved from the CTP database just in time to be processed and passed on to the DSS shortly before it is to be activated on the set top boxes, and hence, to ensure that none of the elements in the system are handing or storing more data that is really necessary.

In the preferred embodiment, the EPS resides on a Commerce Application Server (CAS) that is located at each cable system head end. The CTP database resides on a regional server that communicates with several CAS's, preferably via TCP/IP links. This distributed server architecture is described in greater detail in co-pending U.S. patent application S/N 09/384,182, filed Aug. 27, 1999 (Attorney Docket 3011-02) having the same assignee as the present application, and whose content is incorporated herein by reference. However, the CTP database 6 and EPS 7 could easily be relocated to achieve the same functionality in a differently structured environment.

Referring again to FIG. 1A, the DSS 8 receives complete programming enhancements in the form of XML-formatted documents from the EPS 7. The role of the DSS 8 is to queue and broadcast the enhancements in a timely fashion to the set top boxes for which they are intended. The broadcasting of enhancements is done in the preferred embodiment via the vertical blanking interval (VBI) of the analog television signal in each channel, as explained in detail below. For digital systems, the broadcast enhancements can be inserted in a similar fashion into the MPEG data stream of each channel.

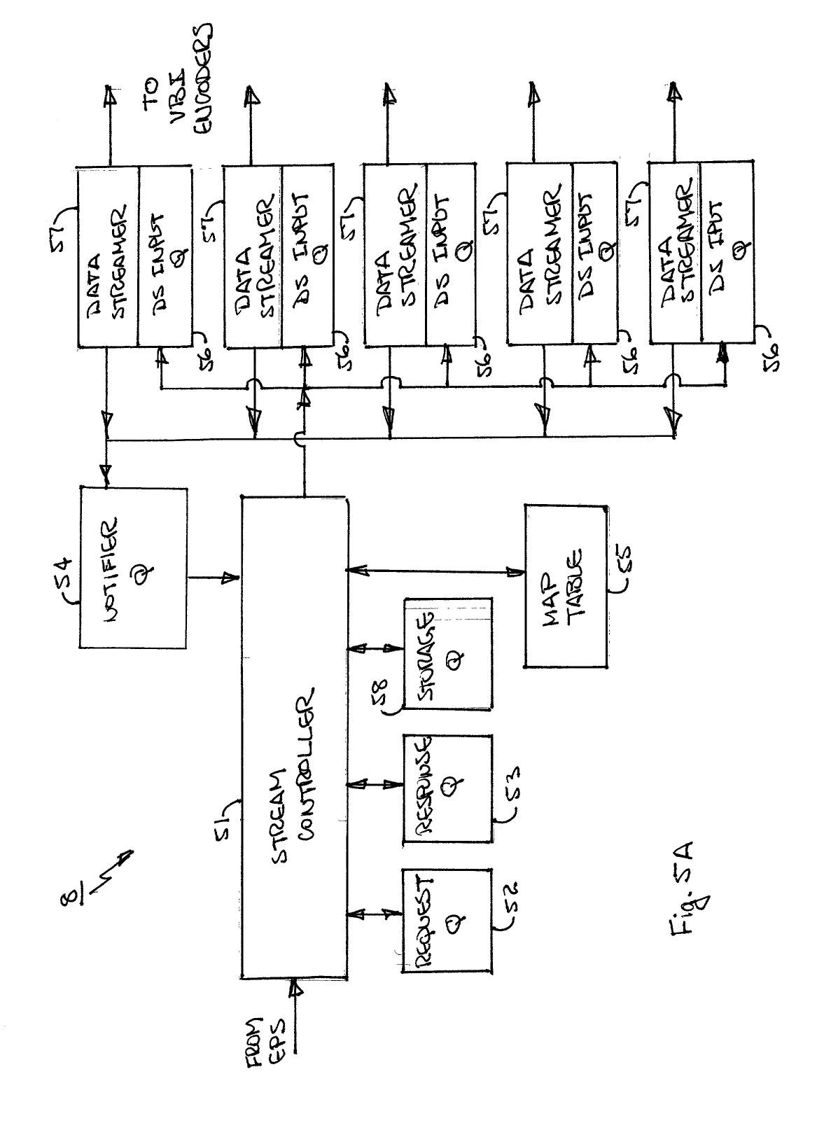

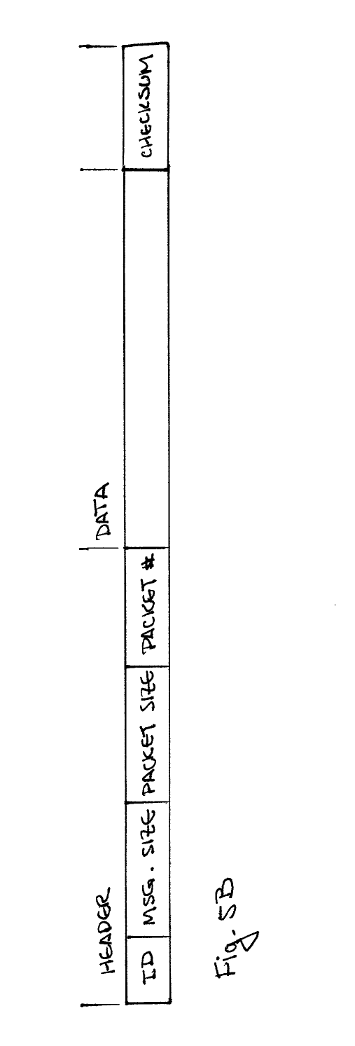

Referring to FIG. 5A, the DSS 8 includes a stream controller 51 connected to a number of data streamers 57. The stream controller and its related data streamers also preferably run on a CAS at each cable system headend. The stream controller 51 controls the overall process of the DSS. In the preferred embodiment, the stream controller is a Microsoft NT application that performs a number of functions. First, it receives the XML-formatted enhancements from the EPS 7 and queues up the enhancements in the data streamers in accordance with the respective destination of each enhancement. The stream controller keeps track of the status of each data streamer and buffers the XML messages until the particular data streamer is ready to accept it. It also starts up, shuts down and reassigns data streamers as required. Upon start-up, the stream controller informs each data streamer to which VBI encoder it is supposed to be connected and therefore, over which channel it will broadcast. The selected data streamer confirms by sending a registration message to the stream controller.

As shown in FIG. 5A, the stream controller sets up a number of message queues to effectively handle its functions. In the preferred embodiment, the queues make use of the Microsoft message queue (MSMQ) mechanism, a general purpose messaging scheme intended to assure communication between a sender and a receiver whether or not both are running at the same time. The data streamer system includes a number of message queues, all which are managed by the stream controller. The system includes a request queue 52, which contains messages from the EPS 7 requesting that specific enhancements be sent. A response queue 53 contains messages from the stream controller indicating whether the specific requests for broadcast of enhancements have been successful or not. A storage queue 58 stores the XML-formatted enhancements until such time as they are sent to the data streamers. A notification queue 54 receives messages from each data streamer as to the status of its ongoing data streaming process. The stream controller monitors the contents of the request queue and the notification queue to evaluate system performance and correct or restart the process as required. The stream controller also maintains a map table 55 that keeps track of which data streamer has been assigned to a particular enhancement and its current status.

Each data streamer 57 contains a data streamer input queue 56 that stores the XML-formatted enhancements forwarded by the stream controller pending transmission over the channel to which the data streamer is assigned. The stream controller 51 sends enhancements to each data streamer 57 in the order of their respective start times. If two enhancements destined for the same data streamer have the same start time, priority is given to the one with the shorter duration.

Referring again to FIG. 1A, each of the data streamers is connected to a VBI encoder 9 (such as the model TES3 manufactured by Norpak Corporation). Successful broadcast of an enhancement occurs when a data streamer indicates to the stream controller that a connection with a designated VBI encoder has been established and the enhancement has been sent to the encoder.

The vertical blanking interval (VBI) is the time it takes for an analog TV signal to retrace itself at the end of a picture field, that is, to move from the bottom of the screen back to the top of the screen. During the blanking interval, no active or viewable picture information is present. Both TVs and video displays position these lines off the top of the visible picture area. The vertical blanking interval lasts for a time equal to 21 horizontal lines of picture. These 21 lines typically contain information such as Vertical Interval Test Signals (VITS), Vertical Interval Reference Signals (VIRS), and Closed Captioning (CC). The present invention uses the vertical blanking interval to multicast in near real-time, enhancement data such as images, lists of products and item details. The present invention permits this type of data, regardless of its interval organization, to be broadcast using one or more lines of the vertical blanking interval. For this application, the in-band, vertical blanking interval provides superior performance to the out-of-band, TCP/IP and BFS (Broadcast File System) data paths provided by some of the more advanced digital TV distribution networks, such as the Scientific-Atlanta system. The TCP/IP path is not acceptable due to low bandwidth, and both TCP/IP and BFS are subject to shared use by other services. The VBI insertion technology allows for a theoretical transfer rate of 2.18 Kbytes per second. Using eight VBI lines yields an approximately 17 Kbytes per second transmission rate, a relatively high bandwidth that has the additional benefit of not interfering with the distribution system's other services.

Transmission of enhancements in the present invention via the VBI makes use of packetized data transmission. Each enhancement is broken up into packets, as shown in FIG. 5B, each of which has, in addition to the packet data, a header containing an enhancement ID and information about the total message size, packet size and packet number.

Referring again to FIG. 1A, the set top box 10 receives the packets, which are identified and reassembled into a complete enhancement message. By broadcasting the complete enhancement message more than once, bad or missing data packets can be replaced. The complete enhancement is stored in memory on the set top box. When an appropriate broadcast-based trigger is received, as explained in further detail below, the enhancement is activated and displayed on the screen of the TV receiver 11, simultaneously with the programming to which it is related. Alternatively, the enhancement can be unrelated to the programming being broadcast, and simply displayed during a specified time period.

FIG. 1B shows the parts of the system, according to the present invention, relating to the use of broadcast triggers for activation of enhancements that have been delivered to and stored in the set top boxes. As noted above with regard to the EBG Application 5 of FIG. 1A, the user can specify through the Trigger tab screen, a triggering method for the enhancement being created. The choices are either “Time” type, meaning that the set top box will use the start and end times specified in the enhancement to determine when the enhancement will be displayed, and “Trigger” (i.e., broadcast-based) type, meaning that the start and end times specified in the enhancement are only used to determine the period during which the enhancement is to be cached, but that the enhancement is not actually activated until a specific trigger is received by the set top box. For broadcast-based triggers, the Trigger tab screen also allows the user to specify a duration, a period of time after activation by the broadcast-based trigger during which the enhancement will remain available to the viewer. Specification of duration assures that the enhancement will become inactive at or before the end of the program segment or commercial message to which it is related.

At the time an enhancement is being created using the EBG application 5 of FIG. 1A, the user can assign a unique identifier (i.e., a character string as described in more detail below) that is inserted into the data file that contains the enhancement. The Trigger tab screen has a Trigger Text window that allows the unique identifier to be included in the EBG Master. The unique identifier serves to identify the enhancement as being associated with a particular program. When the enhancement is broadcast via the Data Streaming System 8 of FIG. 1A, it will be stored in the set top box with the unique identifier.

Again referring to FIG. 1B, a programming source 12 broadcasts program material from a variety of sources, both live and pre-recorded, under the control of a broadcast automation system 14. As the programming is being broadcast, the automation system 14 also automatically causes trigger tool 16 (e.g. the RTG Trigger Generator from RespondTV, Inc., San Francisco, Calif. or the TV Link Creator from Mixed Signals Technologies, Inc., Culver City, Calif., each operating on a standard PC) to insert broadcast-based triggers at appropriate times into the vertical blanking interval of the broadcast signal using a VBI encoder 18. Each trigger contains the unique identifier of an enhancement that has been assigned to the particular program segment during which the trigger is broadcast. The association of a unique enhancement identifier with a particular program segment is established in the EBG master file, which includes for each enhancement both its unique identifier and the corresponding program ID that comes from the program scheduling database 3. At the programming source, each trigger is inserted at a time specified to the automation system 14 by the broadcaster's program schedule (commonly called a play list), which also makes reference to the program ID's. Alternatively, and particularly in the case of live programming, triggers may be inserted manually at the appropriate times using the trigger tool 16.

As previously noted, each broadcast enhancement with its unique identifier embedded in it is stored in a set top box awaiting the arrival of the corresponding program signal carrying a trigger with the identical identifier. The simultaneous presence at the set top box of the enhancement with its identifier and a trigger with an identical identifier causes the enhancement to be activated. The term “activation” means the appearance of an icon on the television screen, superimposed on the video portion of the program, indicating to the viewer that some informational content is available for him or her to view. When the viewer presses an appropriate button on his or her television remote control, this causes the entire enhancement to appear on the screen, waiting for the subscriber to further interact, perhaps by purchasing an item of merchandise, for example. Alternatively, the activation of enhancements can cause the entire enhancement to appear on the screen automatically, without the intervening appearance of the icon.

In a preferred embodiment of the present invention, each broadcast-based trigger is in the form of a text string that is compliant with the ATVEF (Advanced Television Enhancement Forum) specification. The Advanced Enhanced Content Specification, designed by a consortium of broadcast cable networks, consumer electronic companies, television transport operators and technology companies, defines a common, public standard for enhanced interactive television programming. This specification permits enhancements to be authored using a variety of tools and deployed to a variety of televisions, set top boxes and PC-based receivers. It facilitates the delivery of enhanced TV programming over both analog and digital video systems using terrestrial, cable, satellite and Internet networks.

As defined in the above referenced Advanced Enhanced Content Specification, a typical ATVEF-compliant trigger is text based and begins with a required URL (Uniform Resource Locator) enclosed in angle brackets (e.g., <http://xyz.com/fun.html>)followed by attribute/value pairs enclosed in square brackets, i.e.,

<url>[attr1:val1][attr2:val2] . . . [attrN:valN].

In the preferred embodiment of the present invention, the same URL serves as the unique identifier of the corresponding enhancement.

The attributes can be defined as needed. For example, the present invention provides for a unique attribute to differentiate between START and STOP triggers for the particular enhancement identified by the URL. A suitable attribute description would be “CTV” (in this case, indicative of the entity creating the enhancement in question) with two values: START and STOP. Thus, the “start” and “stop” trigger strings would begin respectively, as follows:

<url>[CTV:START] and

<url>[CTV:STOP].

Once the simultaneous presence of identical URL's in a stored enhancement and a START trigger is detected, the enhancement is activated and, preferably, an icon corresponding to the enhancement is immediately displayed of the television screen. The enhancement will remain activated until the set top box receives and detects a STOP trigger in the program signal that has a URL identical to the one embedded in the enhancement. In the event that a STOP trigger is not subsequently received by the set top box, the duration specification in the enhancement, discussed above, will cause the enhancement to be de-activated automatically at the end of the specified duration period, thus assuring that the enhancement will not run over into the next program segment for which it was not intended.

A person of ordinary skill in the art will realize that broadcast-based triggers provide a flexible and powerful method of controlling program enhancements. The generation and use of broadcast-based triggers for broadcast television enhancements is discussed in detail in co-pending U.S. patent application Ser. No. 09/704,717, filed Nov. 3, 2000, having a common assignee with the present application and whose contents are incorporated herein by reference.

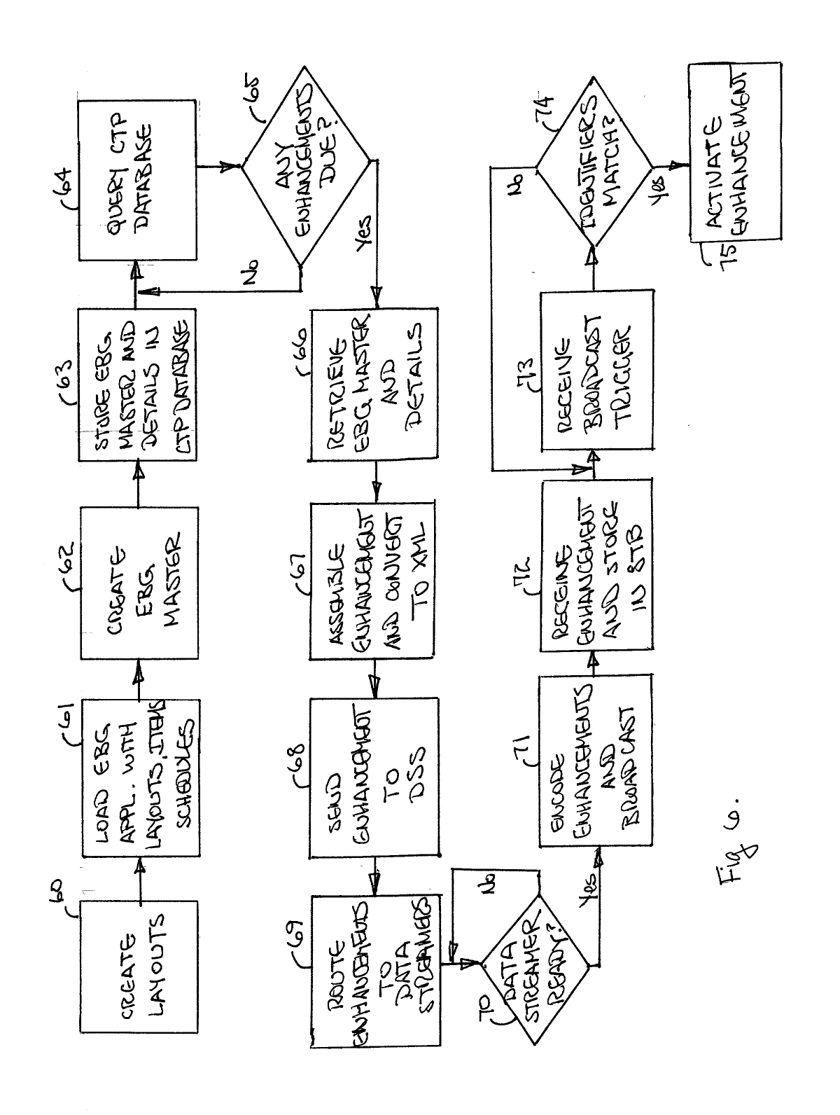

FIG. 6 is a flow chart that summarizes the method described above for creating and delivering program enhancements using the present invention. The process begins with step 60 for creating enhancements using the layout authoring tool. In step 61, the layouts generated by the authoring tool, as well as the purchasable items, and the programming schedules are loaded into the EBG application. These files are used in step 62 to create an EBG master defining the features of the enhancement including the layout, a list of items of purchasable items to be displayed in the enhancement, and the program, date, time with which the display of the enhancement are associated. In step 63, the enhancements, including the EBG master and the details, are stored for future use in this CTP database. At step 64, the EPS, the Enhancement Packaging and Scheduling service, queries the CTP database for the enhancements that will be broadcast in the next interval of time. If CTP returns a list of enhancement to be broadcast in that next time interval at step 65, then at step 66, the EPS retrieves the EBG master and details for the enhancements to be broadcast from the CTP database. In step 67, the EPS assembles the enhancements and converts their respective elements, including the layout, product data, and graphic features into a common XML format. At step 68, the assembled enhancements in XML format are sent to the Data Streamer System (DSS) for “just in time” delivery to the set-top boxes. At step 68, the DSS puts the enhancements into its storage buffer awaiting the availability of a data streamer to route the enhancements to the proper channels for broadcast the set-top boxes. If the data streamer is ready at step 70, then at step 71, the assigned data streamer encodes the enhancement to broadcast it to the set-top boxes over the appropriate channel of the TV distribution network. In step 72, the set-top box receives the enhancement and stores it in memory for display. At step 73, the set-top box receives a trigger broadcast with the programming to which the enhancement is related. Finally, if at step 74, the trigger and enhancement identifiers match, then at step 75, the enhancement is activated, and upon activation the enhancement is display. Otherwise the set top box continues to wait for a matching trigger.

It should be pointed out that enhancements may be created by various entities, such as the advertiser that creates a commercial being enhanced, the production company that creates the program, the network, a network affiliate, or a cable operator. Furthermore, depending on the nature of an enhancement, it might be intended for viewing by television viewers worldwide, only by viewers in certain geographical sections of the country, or perhaps only by viewers served by a particular cable operator head end. Therefore depending upon the attendant circumstances, it is possible that an enhancement may be introduced into the broadcast stream that ultimately is delivered to the set top boxes at various convenient points in the process. It is important to note that the system described herein for the creation and use of broadcast enhancements has broad applicability and is not limited to any particular programming distribution architecture.

Although the described embodiment utilizes the VBI stream within an analog video signal to deliver enhancements to set top boxes in a television distribution network, it will be apparent to a person of ordinary skill that the present invention is equally applicable with obvious modifications to the situation in which the video signal is digital.

It should be pointed out that the present invention can be used not only in the context of an enhancement that is associated with a particular television program, but also in the simpler case of an enhancement that is to be displayed on a dedicated television channel, i.e. a channel in a particular locality that does not carry regular television programming but which is used exclusively for the delivery of interactive enhancements. For example, this could be a shopping channel that displays enhancements in the form of catalog pages or merchandise menus that periodically change, perhaps on an hourly basis.

Although the present invention has been discussed within the context of a cable-based interactive television system, it could easily be applied to a satellite-based system, i.e. one in which the programming is communicated directly to the television STB via satellite. Nor is the invention necessarily limited to video broadcast systems; it is applicable to any other type of broadcast system (e.g., audio) where it is desired to make informational messages available to audience members. For example, instead of using a set top box and a television set, the basic invention could be implemented with any of a variety of consumer information appliances, i.e., individually addressable devices connectable to a network (either wired or wireless) that have a user interface, and which are capable of storing and executing programs and of displaying information. Such appliances include personal digital assistants, personal video recorders, pagers, telephones, personal computers, radios and Internet devices. The present invention is not to be limited in scope by the specific embodiments described herein. Various modifications will be readily apparent to those of ordinary skill in the art based on a review of the specification and drawings, and it is intended that such modifications fall within the scope of the following claims.

What is claimed is:

1. A system for providing product information over a broadcast programming network, comprising:
a first processor configured to associate, in response to a user input, information relating to products with schedule information relating to a television program, including a channel on which, and a date and time at which, the program is to be broadcast;
a second processor configured to direct the broadcast of the product information at a time prior to the time the television program is scheduled to be broadcast; and
a viewer terminal configured to receive the television program and the product information and to display the product information with the television program to a viewer.

2. A system according to claim 1, wherein the first processor is further configured to retrieve the schedule information relating to the television program from a database including schedule information relating to a plurality of current television programs, and to retrieve the product information from a database containing product information relating to a plurality of items available for purchase;

3. A system according to claim 1, wherein the second processor is further configured to broadcast the product information to the viewer terminal on the channel on which the television program is scheduled.

4. A system according to claim 1, wherein the first processor is further configured to associate with the product information, in response to the user input, one of a plurality of formats for displaying the product information with the television program, the second processor is further configured to direct the broadcast of information relating to the one format with the product information, and the viewer terminal is further configured to display the program enhancement in the one format.

5. A system according to claim 4, wherein the second processor is further configured to convert the product information and the associated format information into XML format prior to broadcast, and the viewer terminal is further configured to convert the XML-formatted product information and format information into a form suitable for display to the television viewer.

6. A system according to claim 4, wherein the second processor is further configured to broadcast the product information and the associated format information in the form of digital packets, and the viewer terminal is further configured to receive the digital packets and reconstruct the product information and the format information therefrom.

7. A system according to claim 1, wherein the viewer terminal is further configured to store the received product information and display the stored product information upon receipt of a trigger signal broadcast with the program.

8. A system according to claim 1, wherein the channel on which the program is broadcast carries an analog television signal, and the product information is broadcast via the vertical blanking interval of the analog television signal.

9. A system according to claim 1, wherein the broadcast product information includes a list of products selected by the system user.

10. A system according to claim 9, wherein the broadcast product information further includes additional information in at least one of graphic and text form related to items on the list of products.

11. A system according to claim 1, wherein the first processor is further configured to enable the system user to select by geographic region the channel over which the product information is broadcast.

12. A method for providing product information over a broadcast programming network, comprising:
associating, in response to a user input, information relating to products with schedule information relating to a television program, including a channel on which, and a date and time at which, the program is to be broadcast;
directing the broadcast of the product information at a time prior to the time the television program is scheduled to be broadcast; and
receiving the television program and the product information at a viewer terminal and displaying the product information with the television program to a viewer.

13. A method according to claim 12, further comprising:
retrieving the schedule information relating to the television program from a database including schedule information relating to a plurality of current television; and
retrieving the product information from a database containing product information relating to a plurality of items available for purchase;

14. A method according to claim 12, further comprising:
broadcasting the product information to the viewer terminal on the channel on which the television program is scheduled.

15. A method according to claim 12, further comprising:
associating with the product information, in response to the user input, one of a plurality of formats for displaying the product information with the television program;
directing the broadcast of information relating to the one format with the product information; and
displaying on the viewer terminal the program enhancement in the one format.

16. A method according to claim 15, further comprising:
converting the product information and the associated format information into XML format prior to broadcast; and
converting at the viewer terminal the XML-formatted product information and format information into a form suitable for display to the television viewer.

17. A method according to claim 15, further comprising:
broadcasting the product information and the associated format information in the form of digital packets; and
reconstructing the product information and the format information from the digital packets received at the viewer terminal.

18. A method according to claim 12, further comprising:
storing the received product information at the viewer terminal; and
displaying the stored product information upon receipt of a trigger signal broadcast with the program.

19. A method according to claim 12, wherein the channel on which the program is broadcast carries an analog television signal, and the product information is broadcast via the vertical blanking interval of the analog television signal.

20. A method according to claim 12, wherein the broadcast product information includes a list of products selected in response to the user input.

21. A method according to claim 20, wherein the broadcast product information further includes additional information in at least one of graphic and text form related to items on the list of products.

22. A method according to claim 12, further comprising:
associating the channel over which the product information is broadcast with a geographic region selected in response to the user input.
